(19) United States
(12) Patent Application Publication
(10) Pub. No.: US 2009/0108487 A1
(43) Pub. Date: Apr. 30, 2009

(54) PRODUCING METHOD OF POLYMER FILM

(75) Inventors: Nobuyoshi Suzuki, Kanagawa (JP); Ryou Takeda, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku, Tokyo (JP)

(21) Appl. No.: 11/909,712

(22) PCT Filed: Mar. 20, 2006
(86) PCT No.: PCT/JP2006/306055

§ 371 Date: Sep. 25, 2007

(30) Foreign Application Priority Data
Mar. 25, 2005 (JP) 2005-088520

(51) Int. Cl. B29C 47/04; B29C 47/00

(52) U.S. Cl. 264/171.1; 264/211.12

(57) ABSTRACT

A casting film (80) having a base layer and one outer layer on the base layer is formed by a co-casting. Viscosity of an outer layer dope was at most 40 Pa·s. Just after formation of the casting film (80), the drying air is fed out from an outlet (82a) opening to a belt (73). The temperature and the static pressure are respectively predetermined valued 50-160° C. and 50 Pa-200 Pa. The first outlet is partitioned by partitioning members, and meshed plates are attached to the partitions confronting to both side edge portions of the casting film (80). Another drying air is fed out from an outlet (83a) in a running direction of the belt 73. The temperature and the wind speed are respectively predetermined valued 50° C.-160° C. and 5 m/s-20 m/s. The occurrence of unevenness and foaming was reduced and a film excellent in planarity was produced.

### TECHNICAL FIELD

The present invention relates to a producing method of a polymer film.

### BACKGROUND ART

A polymer film is used in an optical field. Especially, a cellulose aclate film is widely used as an optical film for producing a reasonable and thin liquid crystal device since the cellulose acylate film has merits to be used as a protective film for a polarizing filter.

Such cellulose acylate film is mainly produced by a solution casting method, in which a polymer solution containing polymer (such as cellulose acylate and the like) and solvent is onto a running support to form a casting film. Then the casting film is peeled as a wet film, which is dried to a film.

When it is designated to produce the film by the solution casting method, it is contrived to make the casting speed higher so as to increase the productivity. In this case, for example, an initial drying is made to a surface of the casting film just after the casing onto the support with use of a drying device. Thus the evaporation of the solvent from the casting film effectively proceeds.

However, in the initial drying, if the drying temperature is higher than the boiling point of the solvent contained in the casting film on the support, the evaporation of the solvent cases the foaming in the casting film. Especially, near both side edge portions of the casting film, the thermal energy is easily transmitted from the support to the casting film, and therefore the foaming easily occurs. If the foaming occurs in the casting film like this, the unevenness is formed on the surface of the casting film, and the voids are generated in the casting film. Further, if the drying is made by feeding a drying air whose temperature is controlled to a predetermined value, the drying air causes the drying air causes diagonally extending unevenness (diagonal unevenness) and unevenness of film thickness (thickness unevenness). A generic term of both inclination variation and thickness unevenness is asperity. When the unevenness occurs and the foaming as above in the casting film, the planarity of the film becomes lower. Therefore, the produced film obtained from the casting film is inferior in the planarity.

As developments thereof, an air duct is disposed such that an outlet is directed in a casting direction (or a running direction of the support) with inclination in the range of 45° to 80° to the support. The drying is made by feeding a wind from the outlet (see, Japanese Patent Laid-Open Publication No. 64-55214). Further, a drying air is fed out to a surface of the casting film by an air feeding device, and a heating device heats a rear side of the casting film through a support, so as to dry the casting film (see, Japanese Patent Laid-Open Publication No. 2003-103544).

In the first publication, the dynamic pressure of the drying air from the outlet changes, which causes the generation of unevenness of the surface of the casting film. In the second publication, the drying is made from both surface side of the casting film so as to reduce the lack of drying and the generation of unevenness, while the casting film is dried. However, in this method, it is difficult that the produced film has the enough planarity. Because, in recent years, the more excellent planarity is required for the optical film. Further, in both methods, it is too hard to prevent the foaming in the casting film (especially near both side edge portions).

An object of the present invention is to provide a producing method of a polymer film whose planarity is excellent, since the foaming of the casting film (especially near both side edge portions thereof) is formed by casting a dope on a support.

### DISCLOSURE OF INVENTION

In order to achieve the object and the other object, in a method of producing a film from a casting dope containing solvent and polymer, after the casting dope is cast on a running support to form a casting film, a first drying air is fed out from at least one first outlet confronting to the support so as to extend in a widthwise direction of the support and be situated closely in downstream from the casting die. A temperature of the first drying air is almost constant in the range of 50° C. to 160° C., and a static pressure to the first drying air at the feeding is in the range of 50 Pa to 200 Pa. Then a second drying air is fed out from a second outlet disposed in downstream from the first outlet and in a casting side from the support when a content of remaining solvent in the casting film decreases to a predetermined value. The outlet opens in a running direction such that the drying air may flow in parallel to the support. The casting film containing the solvent is peeled as film. Then the film containing the solvent is dried.

Preferably, a plurality of partitioning members are disposed in the first outlet so as to partition the first outlet into at least three partitions in a widthwise direction of the support. Particularly, air volume regulation members are attached onto the closest partitions to both side edge portions of the casting film, so as to regulate a volume of the first drying air in a widthwise direction of the support.

Preferably, the feeding of the first drying air is performed until the content of remaining solvent in the casting film decreases to 250 wt. %.

Preferably, a temperature of the second drying air is almost constant in the range of 50° C. to 160° C. and a wind speed of the second drying air is almost constant in the range of 5 m/s to 20 m/s.

Preferably, the casting film has a multi-layer structure constructed of a base layer contacting to the support and an exposure layer exposed to an atmosphere. The casting dope includes a base layer dope for forming the base layer and an exposure layer dope for forming the exposure layer. The casting of the casting dope is a co-casting of the base layer dope and the exposure layer dope. Especially preferably, a viscosity of the exposure layer dope is at most 40 Pa·s.

Preferably the first outlet has a slit-like form and a plurality of the first outlets is arranged in the running direction of the support. Particularly preferably, an angle of a feeding direction of the first drying air toward the casting film on the support to the running direction of the support is in the range of 30° to 90°.

According to the present invention, when the dope is cast onto the support to form the casting film, the occurrence of the foaming during the evaporation of the solvent is prevented in the casting film, especially in both side edge portions of the casting film. Thus the produced film is excellent in planarity.

### BRIEF DESCRIPTION OF DRAWINGS

FIG. 1 is a schematic diagram of a dope production line in the present invention;

FIG. 2 is a schematic diagram of a film production line of the present invention;

FIG. 3 is an exploded partial view of a casting chamber in the film production line, showing the disposition of first-third air ducts;

FIG. 4 is an exploded view of a bottom of the first air duct;

FIGS. 5A & 5B are respectively plan views of a punch plate and a slit plate which are set to outlets of the first air duct.

### BEST MODE FOR CARRYING OUT THE INVENTION

As polymer in this embodiment, cellulose acylate is used and especially preferably triacetyl cellulose. As for cellulose acylate, it is preferable that the degree of substitution of acyl groups for hydrogen atoms on hydroxyl groups of cellulose preferably satisfies all of following formulae (I)-(III).

2.5≦A+B≦3.0 (I)

0≦A≦3.0 (II)

0≦B≦2.9 (III)

In these formulae (I)-(III), A is the degree of substitution of the acetyl groups for the hydrogen atoms on the hydroxyl groups of cellulose, and B is the degree of substitution of the acyl groups for the hydrogen atoms while each acyl group has carbon atoms whose number is from 3 to 22. Note that at least 90 wt. % of TAC is particles having diameters from 0.1 mm to 4 mm. However, the polymer to be used in the present invention is not restricted in cellulose acylate, but may be the already-known polymers from which the film can be produced by a solution casting method.

As solvents for preparing the dope, there are aromatic hydrocarbons (for example, benzene, toluene and the like), hydrocarbon halides (for example, dichloromethane, chlorobenzene and the like), alcohols (for example, methanol, ethanol, n-propanol, n-butanol, diethyleneglycol and the like), ketones (for example, acetone, methylethyl ketone and the like), esters (for example, methyl acetate, ethyl acetate, propyl acetate and the like), ethers (for example, tetrahydrofuran, methylcellosolve and the like) and the like.

The solvents are preferably hydrocarbon halides having 1 to 7 carbon atoms, and especially dichloromethane. Then in view of the solubility of cellulose acylate, the peelability of a casting film from a support, a mechanical strength of a film, optical properties of the film and the like, it is preferable that one or several sorts of alcohols having 1 to 5 carbon atoms is mixed with dichloromethane. Thereat the content of the alcohols to the entire solvent is preferably in the range of 2 mass % to 25 mass %, and particularly in the range of 5 mass % to 20 mass %. Concretely, there are methanol, ethanol, n-propanol, iso-propanol, n-butanol and the like. The preferable examples for the alcohols are methanol, ethanol, n-butanol, or a mixture thereof.

By the way, recently in order to reduce the effect to the environment to the minimum, the solvent composition when dichloromethane is not used is progressively considered. In order to achieve this object, ethers having 4 to 12 carbon atoms, ketones having 3 to 12 carbon atoms, esters having 3 to 12 esters are preferable (methyl acetate is especially preferable), and a mixture thereof can be used. These ethers, ketones and esters may have the ring structure. Further, the compounds having at least two of functional groups (namely, —O—, —CO— and —COO—) in ethers, ketones and esters can be used for the solvent. Note that the solvent compounds may have other functional groups, such as alcoholic hydroxyl group and the like. If the solvent contains at least two sorts of the solvent compounds, a number of the carbon atoms may be in the described range of each compound having the above functional group.

The detail explanation of cellulose acylate is made from [0140] to [0195] in Japanese Patent Laid-Open Publication No. 2005-104148. The description of this publication is also applied to the present invention. Further, the additives (such as the solvent, plasticizer, deterioration inhibitor, UV absorbing agent, optically anisotropic controller, retardation controller, dyne, matting agent, release agent, releasing accelerator and the like) are described in detail from [1096] to [0516] of Japanese Patent Laid-Open Publication No. 2005-104148.

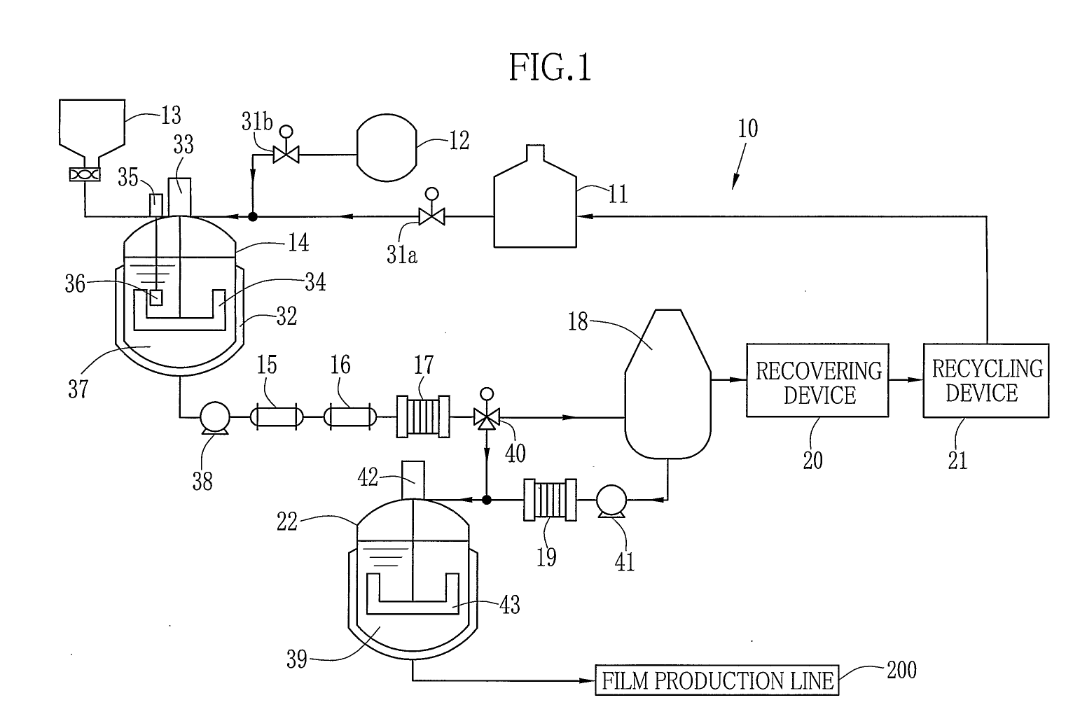

It is to be noted in a dope production line 10 that the production method of the dope used in the present invention is not restricted in the embodiment shown in FIG. 1. The dope production line 10 is constructed of a solvent tank 11, an additive tank 12, a hopper 13, a mixing tank 14, a heating device 15 for heating a swelling liquid 15 (to be explained layer in detail) and a temperature controlling device 16 for controlling the temperature of the swelling liquid 15. Further, there are a filtration device 17, a flushing device 18, a filtration device 19, a recovering device 20 for recovering the solvent, a recycling device 21 for recycling the recovered solvent, and a stock tank 22. The dope production line 10 is connected through the stock tank 22 to a film production line.

When a valve 31a is opened, the solvent is sent from the solvent tank 11 to the mixing tank 14. Then adequate amount of cellulose acylate is sent from the hopper 13 to the mixing tank 14. Thereafter, a valve 31b is opened such that the additive is sent from the additive tank 12 to the mixing tank 14.

The method of feeding the additive to the dissolution tank is not restricted in the above description. If the additive is in the liquid state in the room temperature, it may be fed in the liquid state to the mixing tank 14 without preparing for the additive solution. Otherwise, if the additive is in the solid state in the room temperature, it may be fed in the solid state to the mixing tank 14 with use of a hopper. If plural sorts of additive compounds are used, the additive containing the plural additive compounds may be accumulated in the additive tank 12 altogether. Otherwise plural additive tanks may be used so as to contain the respective additive compounds, which are sent through independent pipes to the mixing tank 14.

In the above explanation, the solvent (or mixture of solvent compounds), the cellulose acylate, and the additive are sequentially sent to the mixing tank 14. However, the sending order is not restricted in it. For example, after the predetermined amount of cellulose acylate is sent to the mixing tank 14, the feeding of the predetermined amount of the solvent and the additive may be performed to obtain a cellulose acylate solution. Otherwise, it is not necessary to feed the additive to the mixing tank 14 previously, and the additive may be added to a mixture of TAC and solvent in following processes.

The mixing tank 14 is provided with a jacket 32 covering over an outer surface of the mixing tank 14, a first stirrer 34 to be rotated by a motor 33, and a second stirrer 36 to be rotated by a motor 35. The first stirrer 34 preferably has an anchor blade, and the second stirrer 36 is preferably an eccentric stirrer of a dissolver type. The jacket is provided with a temperature controlling device for controlling the temperature of a heat transfer medium flowing in the jacket. Thus the inner temperature in the mixing tank 14 is controlled. The preferable inner temperature is in the range of −10° C. to 55° C. At least one of the first and second stirrers 34, 36 is adequately chosen for performing the rotation. Thus a swelling liquid 37 in which TAC is swollen in the solvent is obtained.

In a downstream from the mixing tank 14, the dope production line 10 further includes a pump 38, a heating device 15, the temperature controlling device 16, a filtration device 17, and the stock tank 22.

The pump 38 is driven such that the swelling liquid 37 in the mixing tank 14 may be sent to the heating device 15 which is preferably a pipe with a jacket. Further, the heating device 15 preferably pressurizes the swelling liquid 37. While the swelling liquid 37 is continuously in only the heating condition or both of the heating and pressurizing condition, the dissolution of TAC proceeds such that the swelling liquid 37 may be a polymer solution. Note that the polymer solution may be a solution in which the polymer is entirely dissolved and a swelling liquid in which the polymer is swollen. Further, the temperature of the swelling liquid 37 is preferably in the range of 0° C. to 97° C. Instead of the heat-dissolution with use of the heating device 15, the swelling liquid 37 may be cooled in the range of −100° C. to −10° C. so as to perform the dissolution, which is already known as the cool-dissolution method. In this embodiment, one of the heat-dissolution and cool-dissolution methods can be chosen in accordance with the properties of the materials, so as to control the solubility. Thus the dissolution of TAC to the solvent can be made enough. The polymer solution is fed to the temperature controlling device 16, so as to control the temperature nearly to the room temperature.

Then the polymer solution is fed to the filtration device 17, such that impurities may be removed from the polymer solution. The filter material of the filtration device 17 preferably has an averaged nominal diameter of at most 100 μm. The flow rate of the filtration in the filtration device 17 is preferably at least 50 liter/hr.

In this embodiment, the polymer solution after the filtration is sent through a valve 40 to the flushing device 18 for concentrating the polymer solution. In the flushing device 18, the solvent of the polymer solution is partially evaporated. The solvent vapor generated in the evaporation is condensed by a condenser (not shown) to a liquid state, and recovered by the recovering device 20. The recovered solvent is recycled by the recycling device 21 and reused. According to this method, the decrease of cost can be designated, since the production efficiency becomes higher and the solvent is reused.

The polymer solution after the concentrating as the above description is extracted from the flushing device 18 through a pump 41 to a filtration device 19 for removing the undissolved materials in the filtration. Note that the temperature of the polymer solution in the filtration device 19 is preferably in the range of 0° C. to 200° C. Further, in order to remove bubbles generated in the polymer solution, it is preferable to perform the bubble removing treatment at the same time. As a method for removing the bubble, there are many methods which are already known, for example, an ultrasonic irradiation method and the like. The polymer solution after the filtration is stored in the stock tank 22, which is provided with a stirrer 43 rotated by a motor 42. The stirrer 43 is rotated so as to continuously stir the dopes.

Note that the method of producing the polymer solution is disclosed in detail in [0517] to [0616] in Japanese Patent Laid-Open Publication No. 2005-104148, for example, the dissolution method and the adding methods of the materials, the raw materials and the additives in the solution casting method for forming the TAC film, the filtering method, the bubble removing method, and the like.

[Solution Casting Method]

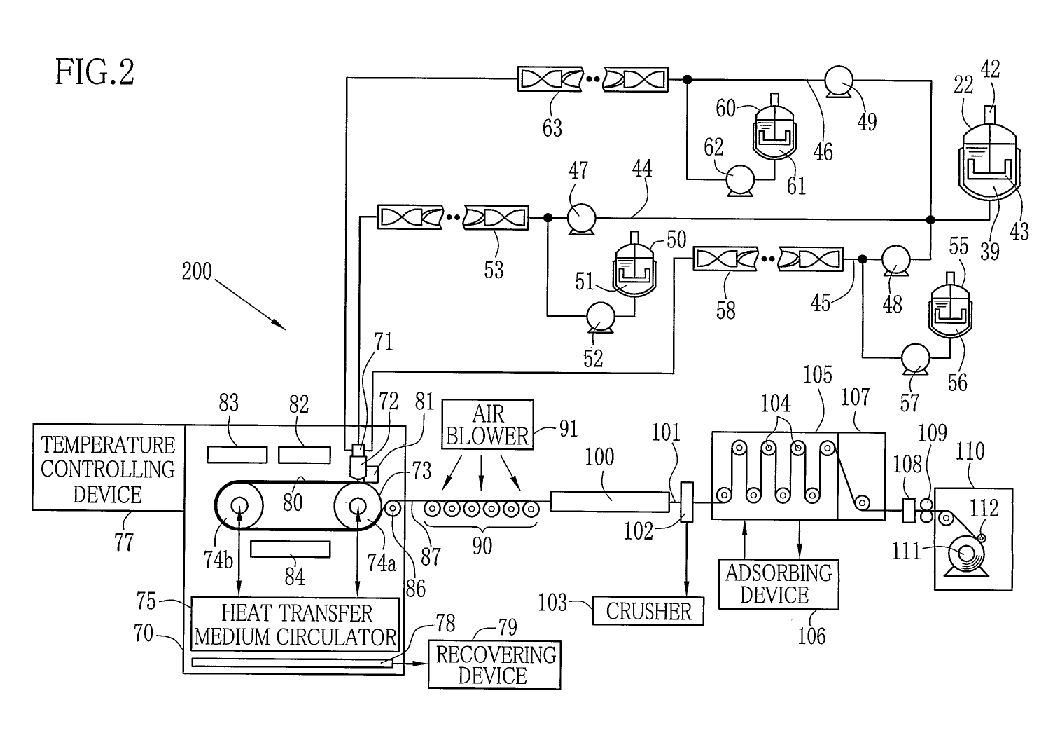

An embodiment of the solution casting method will be described in reference with FIG. 2, now. However, the present invention is not restricted in the embodiment.

In a film production line 200, a casting dope including plural sorts of dopes is cast onto a belt 73 so as to form a casting film 80 having a multi-layer structure. Especially, in following, the casting film 80 has three layers, namely, a base layer and first and second outer layers contacting to the base layer. Therefore, the casting film 80 is peeled from the belt as film 101 having three layer structure. Further, in the preparation, three sorts of dopes are prepared, and three paths 44-46 for preparing the respective dopes are connected to the stock tank 22.

The polymer solution 39 is fed through the path 44 for preparing a dope for base layer (hereinafter, base layer dope). Then an additive 51 is stored in the stock tank 50 is fed by a pump 52 and added to the polymer solution 39. Thereafter, the mixture is mixed and stirred by a static mixer 53 to be uniform. Thus the base layer dope is obtained. The additive 51 is a solution (or a dispersion) previously containing additive compounds, for example, UV absorbing agent, retardation controller and the like.

The polymer solution 39 is fed through the path 44 for preparing a dope for first outer layer (hereinafter, first outer layer dope). Then an additive 56 is stored in the stock tank 55 is fed by a pump 57 and added to the polymer solution 39. Thereafter, the mixture is mixed and stirred by a static mixer 58 to be uniform. Thus the first outer layer dope is obtained. The additive 56 previously contains additive compounds, for example, peeling agent (for example citric acid ester and the like) which makes the peeling of the polymer film from a belt as the support easy, matting agent (silicone dioxide and the like) for reducing the adhesion of film surfaces in the film roll, and the like. Note that the additive 56 may contain the additive compounds, such as plasticizer, UV absorbing agent and the like.

The polymer solution 39 is fed through the path 46 for preparing a dope for second outer layer (hereinafter, second outer layer dope). Then an additive 61 is stored in a stock tank 60 is fed by a pump 62 and added to the polymer solution 39. Thereafter, the mixture is mixed and stirred by a static mixer 63 to be uniform. Thus the first outer layer dope is obtained. The additive 61 contains the additive compounds, such as matting agent (silicone dioxide and the like) for reducing the adhesion of film surfaces in the film roll, and the like. Note that the additive 61 may contain the additive compounds, such as peeling accelerator, plasticizer, UV absorbing agent and the like.

In the casting chamber 70, there are a casting die 72, back-up rollers 74a, 74b, a belt 73 supported by the back-up rollers 74a, 74b, a heat transfer medium circulator 75 and a temperature controlling device 77, and a condenser 78.

The materials of the casting die 72 are preferably precipitation hardening stainless steel. The preferable material has coefficient of thermal expansion of at most 2×10⁻⁵(° C.⁻¹). Further, the material to be used has an anti-corrosion property, which is almost the same as SUS316, in the examination of forcible corrosion in the electrolyte solution. Preferably, the materials to be used for the casting die 72 has such resistance of corrosion that the pitting doesn't occur on the gas-liquid interface even if the material is dipped in a mixture of dichloromethane, methanol and water for three months. The casting die 72 is preferably manufactured by performing the polishing after a month from the material casting. Thus the surface condition of the dope flowing in the casting die 72 is kept uniform. The finish precision of a contact face of the casting die to the dopes is at most 1 μm in surface roughness and at most 1 μm/m in straightness. The clearance of a slit of the casting die 72 is automatically adjustable in the range of 0.5 mm to 3.5 mm. According to an edge of the contact portion of a lip end of the casting die 72 to the dope, R(R is chamfered radius) is at most 50 μm in all of a width. Further, the shearing rate in the casting die 72 is controlled in the range of 1 to 5000 per second.

A width of the casting die 72 is not restricted especially. However, the width is preferably at least 1.1 times and at most 2.0 times as large as a film width. During the film production, it is preferable to provide a temperature controlling device (heater, jacket and the like) for keeping the temperature of the casting die 72 to a predetermined value. Furthermore, the casting die 72 is preferably a coat hanger type die. Further, in order to adjust a film thickness, the casting die 72 is preferably provided with an automatic thickness adjusting device. For example, thickness adjusting bolts (heat bolts) are disposed at a predetermined interval in a widthwise direction of the casting die 72. According to the heat bolts, it is preferable that the profile is set on the basis of a predetermined program, depending on feed rate of pumps (preferably, high accuracy gear pumps) 47-49, while the film production is performed. Further, the film production line 200 may be provided with a thickness meter (not shown), such as infrared ray thickness meter and the like. In this case, the feed back control of the adjustment value of the heat bolts may be made by the adjusting program on the base of the profile of the thickness meter. The thickness difference between any two points in the widthwise direction except the side edge portions in the casting film is controlled preferably to at most 1 μm. The difference between the maximum and the minimum of the thickness in the widthwise direction is at most 3 μm. Further, the accuracy to the designated object value of the thickness is preferably in ±1.5 μm.

Preferably, a hardened layer is preferably formed on a top of a lip end of the casting die 72. A method of forming the hardened layer is not restricted. But it is, for example, ceramics hard coating, hard chrome plating, neutralization processing, and the like. If ceramics is used as the hardened layer, it is preferable that the used ceramics is grindable but not friable, with a lower porosity, high resistance of corrosion, and poor adhesiveness to the casting die 72. Concretely, there are tungsten carbide (WC), Al₂O₃, TiN, Cr₂O₃, and the like. Especially preferable ceramics is tungsten carbide. Tungsten carbide coating can be made by a spraying method.

Further, in order to prevent the partial dry-solidifying of the dopes flowing on slit ends of the casting die 72, it is preferable to provide a solvent supplying device (not shown) at the slit ends, on which a gas-liquid interfaces are formed between both edges of the slit and between both bead edges and the outer gas. Preferably, these gas-liquid interfaces are supplied with the solvent which can dissolve the dope, (for example a mixture solvent of dichloromethane 86.5 pts.mass, acetone 13 pts.mass, n-butanol 0.5 pts.mass). The supply rate to each slit end is preferably in the range of 0.02 mL/min to 1.0 mL/min, in order to prevent the foreign materials from mixing into the casting film. Note that the pump for supplying the solvent has a pulse rate (or ripple factor) at most 5%.

A belt 73 is positioned below the casting die 72, and lapped on the back-up rollers 74a, 74b. When the back-up rollers 74a, 74b are rotated by the driving device (not shown), and thus the belt 73 runs endlessly in accordance with the rotation of the back-up rollers 74a, 74b. Then the casting speed is preferably in the range of 10 m/min to 200 m/min. Further, the temperatures of the back-up rollers 74a, 74b are controlled by the heat transfer medium circulator 75 for cycling a heat transfer medium. It is preferable that the surface temperature of the belt 73 is adjusted in the range of −20° C. to 40° C. by heat transmission from the back-up rollers 74a, 74b. In this embodiment, paths (not shown) of the heat transfer mediums are formed in the back-up rollers 74a, 74b, and the heat transfer mediums whose temperatures are controlled by the heat transfer medium circulator 75 pass through the paths. Thus the temperature of the back-up rollers 74a, 74b are kept to the predetermined values.

The width, the length and the material of the belt 73 are not restricted especially. However, it is preferably 1.1 to 2.0 times as large as the casting width. Preferably, the length is from 20 m to 200 m, and the thickness is from 0.5 mm to 2.5 mm. The surface is preferably polished so as to have a surface roughness at most 0.05 μm. The belt 73 is preferably made of stainless steel, and especially of SUS 316 so as to have enough resistance of corrosion and strength. The thickness nonuniformity of the entire belt 73 is preferably at most 0.5%.

In the drive of the back-up rollers 74a, 74b, a tension occurring to the belt 73 is preferably 5×10⁴ kg/m. The difference of the rotating speed between the rollers 74a, 74b is controlled to at most 0.01 m/min. Preferably, the fluctuation of the running speed of the belt is in 0.5%, and the positional fluctuation of the belt 73 in the widthwise direction in one rotation is at most 1.5 mm. In order to control the fluctuation, it is preferable that a detector (not shown) for detecting both side edge portions of the belt 73 and the feed back control is made on the basis of the measured value. Furthermore, just below the casting die 72, the positional variation of the belt 73 in up- and downwards in accordance with the rotation of the rollers 74a and 74b is preferably at most 200 μm.

Note that it is possible to use one of the back-up rollers 74a, 74b as support. In this case, the back-up roller used as support is preferably rotated at high accuracy such that a rotation flutter may be at most 0.2 mm. Therefore the surface roughness is preferably at most 0.01 μm. Further, the chrome plating is preferably performed to the drum such that the drum may have enough hardness and endurance. As described above, it is preferable in the support that the surface defect must be reduced to be minimal. Concretely there are no pin hole of at least 30 μm, at most one pin hole in the range of 10 μm to 30 μm, and at most two pin holes of less than 10 μm per 1 m².

A temperature controlling device 77 is provided for controlling the inner temperature of a casting chamber 70 in the range of −10° C. to 57° C. Further, a condenser 78 is provided for condensing organic solvent evaporated in the casting chamber 70. Further a recovering device 79 for recovering the condensed organic solvent outside the casting chamber 70.

Further, the cast dope forms a bead between the casting die 72 and the belt 73. In order control the pressure in a rear side of the bead, it is preferable to dispose a decompression chamber 81. Thus the formation of the bead is stabilized, and the wobbling of the bead is reduced. Preferably, the pressure of the bead is from 5 Pa to 1000 Pa lower in the back side than the front side of the bead. Further, in order to control an inner temperature of the decompression chamber 81, there is preferably a jacket (not shown). The inner temperature is not restricted especially, but preferably in the range of 25° C. to 55° C. Furthermore, in order to keep the form of the bead, an aspirating device (not shown) is preferably provided at edge positions of the casting die 72. The aspiration rate of air is preferably in the range of 1 L/min to 100 L/min.

In order to evaporate the solvent in the casting film 80, it is preferable to provide first to third air ducts 82-84. The first air duct 82 is disposed in upper and upstream side of the belt 73, the second air duct 83 is disposed in upper and downstream side, and the third air duct 84 is disposed in lower side. Note that the positions of the air ducts 82-83 are not restricted in this embodiment. Note that the detail explanation about the first-third air ducts will be made later.

The casting film 80 is peeled as film 101 from the belt 73 with support of a roller 86, and transported through a transfer area 90 to a tenter device 100.

In the transfer area 90, there are rollers and an air blower 91. In the tenter device 100, the film 101 is stretched in widthwise direction and relaxed, such that a predetermined optical properties are made. In this case, the stretch ratio as percentage of difference of the film width between after and before the stretch is in the range of 0.5% to 300%. Preferably, the inside of the tenter device 100 are partitioned to a plurality of temperature areas in which inner temperatures are different. Note that it is preferable to draw the film 101 in one of the casting directions. In this case, the draw ratio as percentage of difference of the film length between after and before the drawing is in the range of 0.5% to 300%. Furthermore, the edge slitting device 102 slit off both side edge portions of the film 101 into tips, and the tips of both side edge portions are crushed by a crusher connected to the edge slitting device 102.

In a drying device 105, the film 101 is transported with lapping on rollers 104. The solvent vapor evaporated from the film 101 by the drying device 105 is adsorbed by an adsorbing device 106. The film 101 is transported into a cooling chamber 107, and cooled therein to around the room temperature. A humidity control chamber (not shown) may be provided for conditioning the humidity between the drying device 105 and the cooling chamber 107. Thereafter, a compulsory neutralization device (or a neutralization bar) 85 eliminates the charged electrostatic potential of the film 101 to the predetermined value (for example, in the range of −3 kV to +3 kV). The position of the neutralization process is not restricted in this embodiment. For example, the position may be a predetermined position in the drying section or in the downstream side from a knurling roller 109, and otherwise, the neutralization may be made at plural positions. In a winding chamber 110, the film 101 is wound by a winding shaft 111. At this moment, a tension is applied at the predetermined value to a press roller 112.

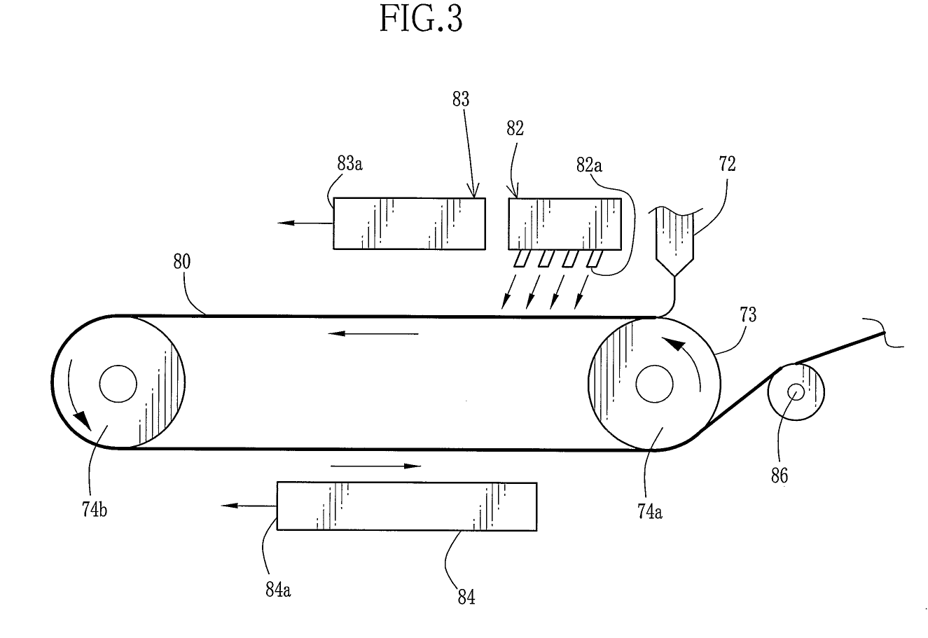

As shown in FIG. 3, just after the position of formation of the casting film 80 by casting the casting dope from the casting die 72 onto the belt 73, the first and second air ducts 82, 83 are disposed, and the third air duct 84 is disposed in lower side of the belt 72. First-third drying airs are respectively fed out from the first-third air ducts 82-84.

The first-third air ducts 82-84 are provided with a air feed controller (not shown) for controlling air feed conditions (air volume, air temperature, humidity and the like) independently, and a air feed section (not shown) for feeding the controlled drying airs by the air feed controller to the first-third air duct 82-84.

The first air duct 82 is provided with outlets 82a confronting to the belt 73, namely opening in a perpendicular direction of the belt 73. Further, the second air duct 83 is provided with an outlet 83a opening in a running direction of the belt 73. The third air duct 84 is provided with an outlet 82a opening in an opposite direction of the running direction of the belt 73, such that the third drying air may flow in the opposite direction of the running direction of the belt 73.

Just after the formation of the casting film 80, the first drying air is fed out through the outlets 82a of the first air duct 82 with temperature control thereof, such that a first drying process may be performed to dry the casting film 80. In performance of the first drying process, the content of remaining solvent is observed at anytime. The method of measuring the content of remaining solvent will be described later. When the content of the remaining solvent becomes predetermined value, the second drying air is fed out through the outlet 83a of the second air duct 83 almost in parallel to the running direction of the belt 73, such that a second drying process may be performed to dry the casting film 80. Further, since the third air duct 84 is disposed in the lower side below the belt 73, the drying of the casting film 80 proceeds furthermore.

As described above, when the first and second drying processes are sequentially made by feeding out respectively the first and second drying airs whose conditions are different, the generation of unevenness (or asperity) including the inclination variation and thickness nonuniformity is reduced, and the foaming in the casting film is reduced, during the drying of the casting film 80. Just after the formation of the casting film 80, since the casting film 80 contains a large content of remaining solvent, the first drying air with control of temperature and static pressure can reduce the generation of the unevenness, and the drying proceeds simultaneously. When the content of remaining solvent decreases to the predetermined value, a surface of the casting film 80 is dried to form a dried layer. In this case, when the first drying air is fed out toward and especially almost perpendicularly to the belt 73, the dried layer forms unevenness, and thus the unevenness is formed on the surface of the casting film 80 after the drying. However, in the present invention, after the first drying process is made so as to reduce the content of remaining solvent to the predetermined value, the second drying process is made to dry the casting film 80, such that the second drying air is fed out almost in parallel to the running direction of the belt 73. In this case, the generation of unevenness on the surface of the casting film 80 is reduced, and the produced film is excellent in planarity.

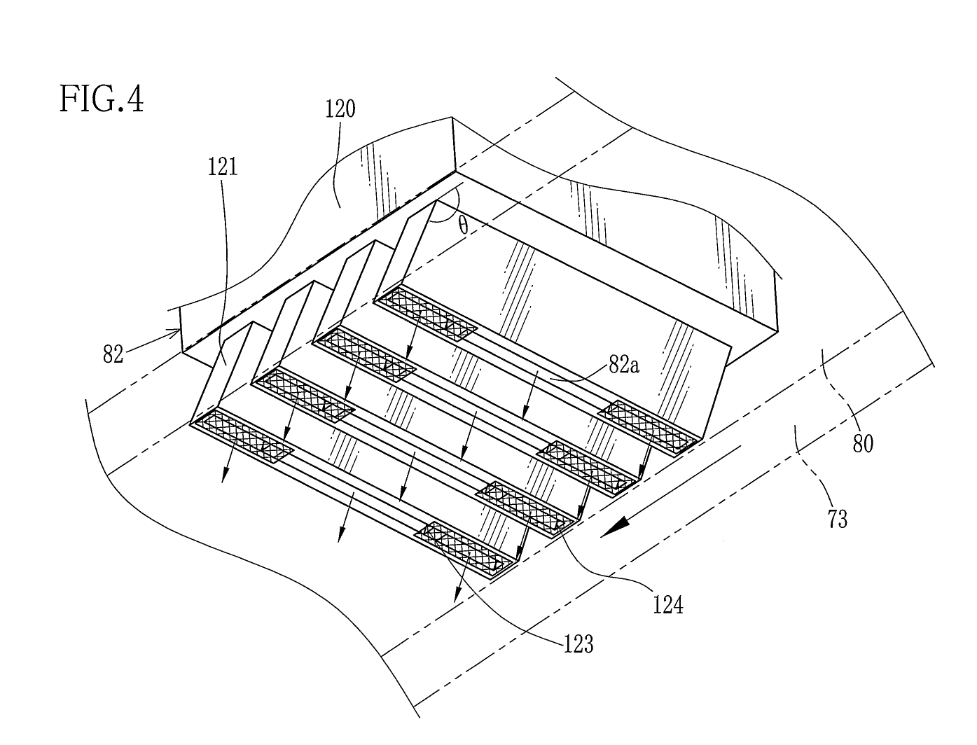

As shown in FIG. 4, a main body 120 of the first air duct 82 is provided with a plurality of nozzles 121 protruding to the belt 73, such that a lengthwise direction of each nozzle 121 may be parallel to the widthwise direction of the belt 73. On a bottom of each nozzle 121, the outlet 82a is formed so as to be a slit-form.

The temperature of the first drying air fed out from each outlet 82a is controlled by a temperature controller which is disposed in an inner side of each outlet 82a. The temperature of the first drying air is almost a predetermined value, preferably in the range of 50° C. to 160° C., particularly 60° C. to 150° C., and especially 60° C. to 140° C. Thus the generation of foaming in the casting film 80 is reduced, and the evaporation of the solvent and the drying proceed. Therefore, the drying time cam be made shorter, and as a result, the production speed can be made larger. However, if the temperature of the first drying air is larger than 150° C., the temperature is too high. Especially, the evaporation of the solvent proceeds near both side edge portions of the casting film 80, and therefore the foaming occurs. In this case, the foaming causes the void in the produced film. Further, in this case, the deterioration of polymer composing the casting film 80 sometimes occurs. If the temperature of the first drying air is at most 60° C., the drying time becomes too long, which causes the insufficiency of drying and the peel remaining of part of the peeled casting film.

A static pressure (Pa) of the first drying air from each outlet 82a is preferably controlled to a predetermined value in the range of 50 Pa to 200 Pa, particularly 60 Pa to 180 Pa, and especially 70 Pa to 170 Pa. Thus the generation of unevenness on the surface of the casting film 80 and the foaming in the casting film 80 are reduced. If the static pressure is larger than 200 Pa, the foaming and some stripes are observed in the casting film 80. If the static pressure is lower than 50 Pa, the pressure for feeding out the first drying air is too weak, and therefore it becomes too hard to make the evaporation of the solvent. Thus the drying of the casting film 80 cannot be made enough, and as a result, some parts of the casting film 80 remains after the peeling.

Inside of each slit outlet 82a, there are partitioning members 123 for partitioning the inside of the nozzle 121 into at least three areas. On two edge areas confronting to both side edge portions of the casting film 80, there are air meshed plate 124 as air volume regulation members. In this case, the resistance to feeding the first drying air becomes larger, and thus the flows of the first drying air through the air meshed plates 124 are applied to both side edge portions of the casting film 80 with volume reduction. Thus the occurrence of the foaming near both side edge portions is reduced in the drying. Note that the first drying air is fed out without volume reduction through the areas in which there are no meshed plates. Thus the drying speed is adjusted in the widthwise direction of the casting film 80 in the drying.

In this embodiment, the air volume regulation members are the air meshed plates 124. However, in the present invention, the air volume regulation members are not restricted in them, so far as the air volume regulation members can resists to the feeding pressure of the first drying air to reduce the air volume.

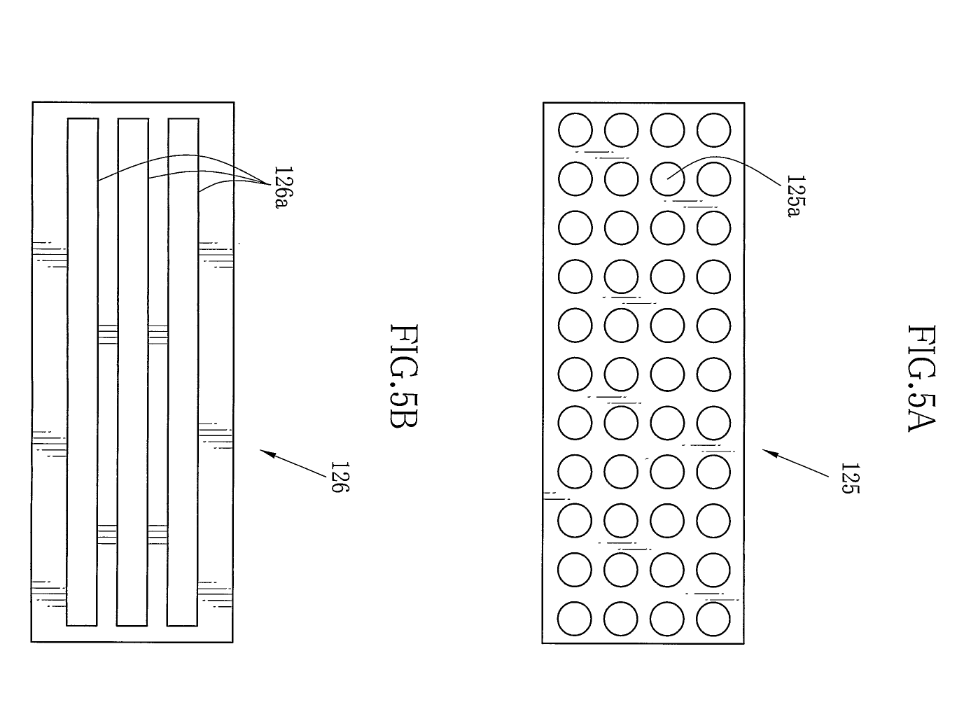

As shown in FIG. 5A, the air volume regulation member may be a punched plate 125 having a plurality of punches 125a. With use of the punched plates 125 as the air volume regulation members, the first drying air is applied to part in which the punches 125a are not formed, such that the feed resistance to the first drying air becomes larger, and as a result, the volume of the first drying air fed out through the punched plates becomes lower. Further, as shown in FIG. 5B, the air volume regulation member may be a slit plate 126 having a plurality of slits 126a. With use of the slit plates 126 as the air volume regulation members, the first drying air is applied to part in which the slits 126a are not formed, the same as with use of the meshed plates 124 and the punched plates 125. Therefore, the feed resistance to the first drying air becomes larger, and as a result, the volume of the first drying air fed out through the punched plates becomes lower. Note that a number, a form and a distribution of the punches 125a and slits 126a are not restricted especially.

In this embodiment, the first air duct 82 used in the first drying process has nozzles 121 protruding from the main body 120 to the belt 73. However, the shape of the first air duct 82 is not restricted especially, so far as the first drying air can be fed out through the slits toward and especially perpendicularly to the belt 73 in the first drying process. For example, the air duct may have a box-like duct main body on whose bottom slits are formed so as to confront to the belt 73.

As shown in FIG. 4, the nozzles 121 having the slit outlets 82a protrudes from the main body 120 to the belt 73 with inclination to a forward side. In this case, it is preferable to set a setting angle θ° of the nozzle 121 to the bottom of the main body 120 in the range of 90° to 150°. Therefore, an angle of a feeding direction of the first drying air toward the casting film 80 on the belt to the running direction of the belt 73 is set in the range of 30° to 90°. Particularly preferably, the first drying air is fed with inclination to the downstream side from the perpendicular direction of the belt 73. Thus the generation of unevenness on the surface of the casting film 80 is reduced.

The length of each outlet 48 in the air ducts 82-84 is not restricted especially. However, the length is the same as or larger than the width of the casting film 80. Thus the first drying air can be applied to whole of the width of the casting film 80, and the first drying air can be effectively applied to the predetermined positions of the casting film 80.

Before the content of the remaining solvent becomes 250 wt. %, the first drying air is fed out to the casting film 80 with use of the first air duct 82. Thus the first drying air with rectification thereof is fed out when the content of the remaining solvent is large. In this case, since the drying of the casting film 80 is made only little, the drying layer is not formed. Therefore, even if the first drying air is applied to the casting film 80 in this situation, the generation of the unevenness is reduced. However, the content of the remaining solvent is less than 250 wt %, the drying is made such that the drying layer is formed. If the first drying air is applied to the casting film 80 in this situation, the unevenness remains on the film surface. Note that the content of the remaining solvent is that on dry basis and measured with use of the samples of the casting film 80 and the produced film which is completely dried. If the sample weight of the casting film 80 was x and the sample weight after the drying was y, the solvent content on the dry basis (%) was calculated in the formula, {(x−y)/y}×100. Note that in the content of the remaining solvent on dry basis, the weight of the solid obtained by completely drying the dope corresponds to 100%.

The temperature of the second drying air fed out from the second air duct 83 is preferably controlled to a predetermined value in the range of 50° C. to 160° C., particularly 60° C. to 150° C., and especially 65° C. to 145° C. Further, the feeding speed of the second drying air is controlled to a predetermined value in the range of 5 m/s to 20 m/s, particularly 8 m/s to 18 m/s. Thus the generation of the unevenness and the foaming in the casting film 80 is reduced in the drying. However, if the temperature and the feeding speed of the second drying air from the second air duct 83 are larger than the above ranges, the evaporation of the solvent cannot proceed effectively, similar to the case of the first drying air from the first air duct 82. Further, the foaming occurs so much in the casting film 80, especially near both side edge portions, and deterioration of polymer composing the casting film 80 easily occurs. If the temperature and the feeding speed of the second drying air from the second air duct 83 are smaller than the above ranges, the temperature and the feeding speed of the second drying air is too low, and therefore the evaporation of the solvent cannot proceed effectively. Thus part of the casting film 80 remains on the belt after the peeling.

In the casting film 80, the first and second outer layers are formed respectively, so as to be a lowermost layer contacting to the belt 73 and an uppermost layer, and the base layer is sandwiched by the first and second outer layers. Note that the casting film 80 having such a multi-layer structure as above is formed by performing the co-casting of several sorts of dopes which are independently prepared. When the casting film 80 having the multi-layer structure is formed by the co-casting, the production speed can be made higher and the unevenness of the film surface can be reduced. Therefore, the produced film is excellent in the surface condition. Note that the method of the co-casting will be described later.

Each viscosity of the dopes for forming the outer layers is preferably controlled to at most 40 Pa·s, particularly at most 35 Pa·s, and especially at most 30 Pa·s. Thus the outer layers are dried faster than the base layer. Thus effects of the protection of the base layer become larger. Thus the foaming caused by evaporating the solvent in the base layer is reduced. If the viscosity of the dope for forming the outer layers larger than 40 Pa·s, the unevenness often occurs on the surface of the casting film 80 easily, or the casting speed becomes lower to elongate the production time.

In following, an embodiment for forming the film in the film production line 200 will be explained. Note that the present invention is not restricted in this embodiment, in reference with FIG. 2.

The base layer dope and the first and second outer layer dopes are fed to a feed block 71 at a predetermined flow volume. The dopes are joined and then cast from the casting die 72 to a belt 73.

The dopes is cast from the casting die 72 onto the belt 73, so as to form the casting film 80 while a bead of the cast dopes is formed between the casting die 72 and the belt 73. At the co-casting, the temperature of the dopes is preferably controlled in the range of −10° C. to 57° C.

When the cast dope has self-supporting property, the casting film 80 is continuously peeled as the film 101 with support of the peeling roller 86. Then the film 101 is transported to the transfer area 90. In the transfer area 90, while the film 101 is transported with the support of the rollers, a drying air is fed from the air blower to dry the film 101, such that the drying may proceed. Preferably, the temperature of the drying air is in the range of 20° C. to 250° C. Note in the transfer area 90 that the rotating speed of the roller may be set to be higher in the downstream side, so as to draw the film 101.

The film 101 is dried until the content of the remaining solvent become the predetermined value, and fed out from the tenter device 100 toward an edge slitting device 102 for slitting off both side edge portions. The slit side edge portions are sent to a crusher 103 by a cutter blower (not shown), and crushed to tips by the crusher 103. The tips are reused for preparing the dope, which is effective in view of the decrease of the production cost. Note that the slitting process of both side edge portions may be omitted. However, it is preferable to perform the slitting between the casting process and the winding process.

The film 101 whose side edge portions are slit off is sent to the drying device 105 and dried furthermore. In the drying device 105, the film 101 is transported with lapping on the rollers 104. The inner temperature of the drying device 105 is not restricted especially. However, it is preferable in the range of 60° C. to 145° C. The solvent vapor evaporated from the film 101 by the drying device 105 is adsorbed by the adsorbing device 106.

The film 101 is transported into the cooling chamber 107, and cooled therein to around the room temperature. A humidity control chamber (not shown) may be provided for conditioning the humidity between the drying device 105 and the cooling chamber 107. Preferably, in the humidity control chamber, an air whose temperature and humidity are controlled is applied to the film 101. Thus the curling of the film 101 and the winding defect in the winding process can be reduced.

Thereafter, a compulsory neutralization device (or a neutralization bar) 108 eliminates the charged electrostatic potential of the film 101 to the predetermined value (for example, in the range of −3 kV to +3 kV). The position of the neutralization process is not restricted in this embodiment. For example, the position may be a predetermined position in the drying section or in the downstream side from the knurling roller 109, and otherwise, the neutralization may be made at plural positions. After the neutralization, the embossing of both side portions of the film 101 is made by the embossing rollers to provide the knurling. The emboss height from the bottom to the top of the embossment is in the range of 1 μm to 200 μm.

In the last process, the film 101 is wound by the winding shaft 111 in the winding chamber 110. At this moment, a tension is applied at the predetermined value to a press roller 112. Preferably, the tension is gradually changed from the start to the end of the winding. In the present invention, the length of the film 101 is preferably at least 100 m. The width of the film is preferably at least 600 mm, and particularly in the range of 1400 mm to 1800 mm. Further, even if the width is more than 1800 mm, the present invention is effective. When it is designated to produce the film which is 15 μm to 100 μm in thickness, the present invention is also applied.

In the solution casting method of the present invention, there are casting methods for casting plural dopes, for example, a co-casting method and a sequential casting method. In the co-casting method, a feed block may be attached to the casting die as in this embodiment, or a multi-manifold type casting die (not shown) may be used. In the production of the film having multi-layer structure, the plural dopes are cast onto a support to form a casting film having the base layer and the first and second outer layers. Then in the produced film, at least one of the thickness of the first outer layer and that of the second outer layer is preferably in the range of 0.5% to 30% of the total film thickness. Furthermore, when it is designated to perform the co-casting, a dope of higher viscosity is sandwiched by lower-viscosity dopes. Concretely, it is preferable that the dopes for forming the surface layers have lower viscosity than the dope for forming a layer sandwiched by the surface layers. Further, when the co-casting is designated, it is preferable in the bead between a die slit (or die lip) and the support that the composition of alcohol is higher in the two outer dopes than the inner dope.

As shown in FIG. 2, since the co-casting of three dopes is made, the produced film has the predetermined properties. When the film 101 is wound up to the film roll, it is necessary to prevent the adhesion of the film in the film roll. Therefore, it is preferable that the dope contains the matting agents. However, the matting usually agents cause the degradation in the optical properties (for example, the decrease of the transparency). In this embodiment, accordingly, the matting agents are contained in the outer layer dopes. Namely, the inner dope doesn't contain any matting agents. Thus the surface adhesiveness is decreased, and the film can have the designated optical properties.

Japanese Patent Laid-Open Publication No. 2005-104148 describes from [0617] to [0889] in detail about the structures of the casting die, the decompression chamber, the support and the like, and further about the co-casting, the peeling, the stretching, the drying conditions in each process, the handling method, the curling, the winding method after the correction of planarity, the solvent recovering method, the film recovering method. The descriptions thereof can be applied to the present invention.

[Properties & Measuring Method]

(Degree of Curl & Thickness)

Japanese Patent Laid-Open Publication No. 2005-104148 describes from [0112] to [0139] about the properties of the wound cellulose acylate film and the measuring method thereof. The properties and the measuring methods can be applied to the present invention.

[Surface Treatment]

The cellulose acylate film is preferably used in several ways after the surface treatment of at least one surface. The preferable surface treatments are vacuum glow discharge, plasma discharge under the atmospheric pressure, UV-light irradiation, corona discharge, flame treatment, acid treatment and alkali treatment. Further it is preferable to make one of these sorts of the surface treatments.

[Functional Layer]

(Antistatic, Curing, Antireflection, Easily Adhesive & Antiglare Layers)

The cellulose acylate film may be provided with an undercoating layer on at least one of the surfaces, and used in the several ways.

It is preferable to use the cellulose acylate film as a base film to which at least one of functional layers may be provided. The preferable functional layers are an antistatic layer, a cured resin layer, an antireflection layer, an easily adhesive layer, an antiglare layer and an optical compensation layer.

Conditions and Methods for forming the functional layer are described in detail from [0890] to [1087] of Japanese Patent Laid-Open Publication No. 2005-104148, which can be applied to the present invention. Thus, the produced film can have several functions and properties.

These functional layers preferably contain at least one sort of surfactants in the range of 0.1 mg/m² to 1000 mg/m². Further, the functional layers preferably contain at least one sort of plasticizers in the range of 0.1 mg/m² to 1000 mg/m². The functional layers preferably contain at least one sort of matting agents in the range of 0.1 mg/m² to 1000 mg/m². The functional layers preferably contain at least one sort of antistatic agents in the range of 1 mg/m² to 1000 mg/m².

(Variety of Use)

The produced cellulose acylate film can be effectively used as a protection film for a polarizing filter. In the polarizing filter, the cellulose acylate film is adhered to a polarizer. Usually, two polarizing filters are adhered to a liquid crystal layer such that the liquid crystal display may be produced. Note that the arrangement of the liquid crystal layer and the polarizing filters are not restricted in it, and several arrangements already known are possible. Japanese Patent Laid-Open Publication No. 2005-104148 discloses the liquid crystal displays of TN type, STN type, VA type, OCB type, reflective type, and other types in detail. The description may be applied to the present invention. Further, in this publication No. 2004-264464 describes a cellulose acylate film provided with an optical anisotropic layer and that having antireflection and antiglare functions. Further, the produced film can be used as an optical compensation film since being double axial cellulose acylate film provided with adequate optical properties. Further, the optical compensation film can be used as a protective film for a polarizing filter. The detail description thereof is made from [1088] to [1265] in the publication No. 2005-104148.

In the method of forming the polymer film of the present invention, the formed cellulose acylate film is excellent in optical properties. The TAC film can be used as the protective film for the polarizing filter, a base film of the photosensitive material, and the like. Further, in order to improve the view angular dependence of the liquid crystal display (used for the television and the like), the produced film can be also used for the optical compensation film. Especially, the produced film is effectively used when it doubles as protective film for the polarizing filter. Therefore, the film is not only used in the TN-mode as prior mode, but also IPS-mode, OCB-mode, VA-mode and the like. Further, the polarizing filter may be constructed so as to have the protective film as construction element.

In the method of forming the polymer film of the present invention, the formed cellulose acylate film is excellent in optical properties. The TAC film can be used as the protective film for the polarizing filter, a base film of the photosensitive material, and the like. Further, in order to improve the view angular dependence of the liquid crystal display (used for the television and the like), the produced film can be also used for the optical compensation film. Especially, the produced film is effectively used when it doubles as protective film for the polarizing filter. Therefore, the film is not only used in the TN-mode as prior mode, but also IPS-mode, OCB-mode, VA-mode and the like. Further, the polarizing filter may be constructed so as to have the protective film as construction element.

In followings, Experiment of the present invention will be explained. However, the present invention is not restricted in it. The explanation will be made in detail according to Example 1. In Examples 2-8, the same explanations will be omitted as Example 1.

### EXAMPLE 1

In Example 1, the materials of the following contents are used for producing the dope.

(Composition)

| | | |
|---|---|---|
| Cellulose Triacetate | 100 | pts.mass |
| (Powder: degree of substitution, 2.84; | | |
| viscosity-average degree of polymerization, | | |
| 306; water content, 0.2 mass %; viscosity of | | |
| 6 mass % dichloromethane solution , 315 mPa · s; | | |
| averaged particle diameter, 1.5 mm; | | |
| standard deviation of averaged | | |
| particle diameter, 0.5 mm) | | |
| Dichloromethane (first solvent compound) | 320 | pts.mass |
| Methanol (second solvent compound) | 83 | pts.mass |
| 1-butanol (third solvent comound) | 3 | pts.mass |
| Plasticizer A | 7.6 | pts.mass |
| (trimphenyl phosphate) | | |
| Plasticizer B | 3.8 | pts.mass |
| (diphenyl phosphate) | | |
| Dye | 0.0005 | pts.mass |

According to cellulose triacetate used in this experiment, the remaining content of acetic acid was at most 0.1 mass %, the Ca content was 58 ppm, the Mg content was 42 ppm, the Fe content was 0.5 ppm, the free acetic acid content was 40 ppm, and the sulfuric ion content was 15 ppm. The degree of acetylation at 6^{th} position was 0.91, and the percentage of acetyl groups at 6^{th} position to the total acetyl groups was 32.5%. The acetone extract was 8 mass %, and a ratio of weight-average molecular weight to number-average molecular weight was 2.5. Further, yellow index was 1.7, haze was 0.08, and transparency was 93.5%. Tg (measured by DSC) was 160° C., and calorific value in crystallization was 6.4 J/g. This cellulose triacetate A (hereinafter TAC-A) is synthesized from cellulose as material obtained from cotton.

The polymer solution was prepared with use of the dope production line 30 in FIG. 2. The mixing tank 14 with the first and second stirrers 34, 36 was made of stainless and the volume thereof was 4000 L. Into the mixing tank 14, plural solvent compounds were mixed such that a mixture solvent was obtained. While the stirring of the mixture solvent was made, the cellulose triacetate flakes were added from the hopper 13 to the mixture solvent gradually, such that the total mass of the mixture solution and the cellulose triacetate flakes might be 2000 kg. Note that the water content in each solvent compounds (methyl acetate, n-butanol, acetone and ethanol) is at most 0.5 mass %. The powder of cellulose triacetate was supplied into the dissolution tank. The stirring was made with use of the first stirrer 34 having the anchor blade and the second stirrer 36 which was eccentric stirrer of dissolver type. At first, the first stirrer 34 performed the stirring at one m/sec as circumferential velocity (shear stress was 1×10⁴ kgf/m/sec²), and the second stirrer 36 performed the stirring at shear rate at first 5 m/sec (shear stress was 5×10⁴ kgf/m/sec²). Thus the dispersion was made for 30 minutes during the stirring. The dissolving started at 25° C., and the temperature of the dispersion became 48° C. at last. After the dispersion, the high speed stirring (of the second stirrer 36) was stopped, and the stirring was performed by the first stirrer 34 at 0.5 m/sec as circumferential velocity for 100 minutes. Thus cellulose triacetate flakes was swollen such that the swelling liquid 37 was obtained. Until the end of the swelling, the inner pressure of the mixing tank 14 was increased to 0.12 MPa with use of nitrogen gas. At this moment, the hydrogen concentration in the dissolution tank was less than 2 vol. %, which does not cause the explosion. Further, water content in the polymer solution was 0.3 mass %.

The swelling liquid 37 was fed from the mixing tank 14 to the heating device 15 by the pump 38. The heating device was a pipe provided with a jacket. The swelling liquid 37 was heated to 50° C. by the heating device 15, and then heated to 90° C. under 2 MPa. Thus the dissolution was completely made, and the heating time was 15 minutes. The swelling liquid was fed out as the polymer solution from the heating device 15, and the filtration of the polymer solution was made by the filtration device 17 in which nominal diameter of a filter was 8 μm. Thus the solid content in the polymer solution was 19 mass % after the filtration. In the filtration, it is to be noted that the upstream side filtration pressure was 1.5 MPa, and the downstream side filtration pressure was 1.2 MPa. The filter, a filter housing and the pipes that are used at the high temperature was produced from hasteloy so as to be excellent in corrosion resistance, and had jackets in which heat transfer mediums are fed for heating continuously.

The polymer solution was fed into the flushing device 18 whose pressure was kept to the atmospheric pressure at 80° C., such that the flush evaporation of the polymer solution was made. The solvent vapor was condensed by the condenser to the liquid state, and recovered by the recovering device 20. After the flushing, the content of solid compounds in the polymer solution was 21.8 mass %. Note that the recovered solvent was recycled by the recycling device 21 and reused. The anchor blade is provided at a center shaft of a flush tank of the flushing device 18, and the polymer solution was stirred by the anchor blade at 0.5 m/sec as circumferential velocity. The temperature of the polymer solution in the flush tank was 25° C., the retaining period of the polymer solution in the flush tank was 50 minutes. Part of the polymer solution was sampled, and the measurement of the shearing viscosity was made at 25° C. The shearing viscosity was 450 Pa·s at 10 (1/s) of shearing rate.

Then the defoaming was further made by irradiating very weak ultrasonic waves. Thereafter, the polymer solution was fed to the filtration device 19 by the pump 41. In the filtration device 19, the polymer solution was fed at first through a sintered metal filter whose nominal diameter was 10 μm, and then through the same filter of 10 μm nominal diameter. At the forward and latter filters, the upstream side pressures were respectively 1.5 MPa and 1.2 MPa, and the downstream side pressures were respectively 1.0 MPa and 0.8 MPa. The temperature of the polymer solution after the filtration was controlled to 36° C., and the polymer solution stored as the polymer solution 39 in the stainless stock tank 22 whose volume was 2000 L. The anchor blade is provided to a center shaft of the stock tank 22, and the polymer solution 39 was always stirred by the anchor blade at 0.3 m/sec as circumferential velocity. Note that when the concentrating of the polymer solution is made, corrosions of parts or portions contacting to the polymer solution in the devices and devices didn't occur at all. Further, a mixture solvent MS of dichloromethane 86.5 pts.mass, acetone 13 pts.mass and n-butanol 0.5 pts.mass was prepared.

The film was formed in a film production line 200 shown in FIG. 2. The pumps 47-49 for increasing the upstream side pressures were high accuracy gear pumps and driven to feed the polymer solution 39, while the feed back control was made by an inverter motor. Thus the upstream side pressure of high accuracy gear pump was controlled to 0.8 MPa. As for the pumps 47-49, volumetric efficiency was 99.2%, and the variation rate of the discharging was at most 0.5%. Further, the discharging pressure was 1.5 MPa.

The casting die 72 has the feed block 71 which is 1.8 m in width and adequate for the co-casting, such that not only the base layer dope but also the first and second outer layer dopes on both surfaces of the main dope can be cast simultaneously. Thus the produced film has three-layer structure. The polymer solution 39 was fed through the paths 44-46.

The additive 51 for the base layer was prepared by mixing UV agent A (2(2′-hydroxy-3′,5′-di-tert-butylphenyl)benzo-triazol; 0.7 pts.mass), UV agent B (2(2′-hydroxy-3′,5′-di-tert-amylphenyl)-5-chlorobenzotriazol; 0.3 pts.mass), retardation controller (N,N′-dimethatril-N″-p-methoxyphenyl-1,3,5-triazine-2,4,6-triamine; 4 pts.mass), the mixture solvent MS and the polymer solution 39. The prepared additive 51 was contained in the stock tank 22. Then the additive 51 was fed from the stock tank 22 to the path 44 by the pump 52, and thus added to the polymer solution 39. Thereafter, the mixing was made by the static mixer 53, such that the base layer dope was obtained. The content control was made such that the total solid content might be 21.8 mass %, the content of UV absorbing agents A & B in the produced film might be 1 mass %, and the retardation controller content in the film might be 4 mass %.

Silicone dioxide 0.05 pts.mass (particle diameter, 15 nm; Mohs Hardness, about 7) as matting agent, citric acid ethylester 0.006 pts.mass (citric acid, citric acid monoester, citric acid diester, citric acid triester) as peeling agent and the polymer solution 39 were dissolved to or dispersed in the and the mixture solvent. Thus the additive 56 for the first outer layer was obtained in liquid state. The additive 56 was stored in the stock tank 55, and fed out by the pump 57 at the predetermined flow volume to the polymer solution 39 which is flowing in the path 45. Then the additive 56 and the polymer solution 39 was mixed by the static mixer 58 such that the first outer layer dope was obtained. The content control was made such that the total solid content might be 20.5 mass %, the matting agent content might be 0.05 mass %, and the peeling accelerator content might be 0.03 mass %.

Silicone dioxide 0.1 pts.mass as matting agent was dispersed in the mixture solvent, such that the additive 61 for the second outer layer was obtained in the liquid state. The additive 61 was stored in the stock tank 60, and fed out by the pump 62 to the polymer solution 39 which is flowing in the third path 66. Then the mixture of the additive 56 and the polymer solution 39 is mixed by the static mixer 63 such that the dope for forming the second outer layer was obtained. The content control was made such that the total solid content might be 20.5 mass %, and the matting agent content might be 0.1 mass %.

The thickness of each of the base layer and the first and second outer layers in the TAC film was respectively 4 μm, 73 μm, and 3 μm, and the film thickness was 80 μm. The casting width was 1700 mm, and the flow rate of each cellulose triacetate dope at die lips was adjusted during the casting. The casting die 72 was provided with a jacket in which heat transfer medium was supplied. The casting die 72 was provided with a jacket (not shown) in which a heat transfer medium was supplied. The temperature of the heat transfer medium at an entrance of the jacket was 36° C., such that the temperature of the dope might be 36° C.

The casting die 72 was the coat hunger type, in which heat bolts for adjusting the film thickness were disposed at the pitch of 20 mm. Thus the film thickness (or the thickness of the dopes) are automatically controlled by the heat bolt. A profile of the heat volt can be set corresponding to the flow rate of the high accuracy gear pump, on the basis of the preset program. Thus the feed back control can be made by the control program on the basis of the profile of an infrared ray thickness meter (not shown) disposed in the film production line 200. The control was made such that, with exception of both side edge portions (20 mm each in the widthwise direction of the produced film), the difference of the film thickness between two positions which were 50 mm far from each other might be at most 1 μm, and the largest difference between the minimal values of the film thickness in the widthwise direction might be at most 3 μm/m. Further, the control was made such that the averaged thickness accuracy of each of the first and second outer layers might be ±2%, that of the base layer might be at most 1%, and the average film thickness might be at most ±1.5%.

In the upstream side of the casting die 72, the decompression chamber 81 was provided for decompressing the pressure in the upstream side from the casting die 72. The pressure difference of the downstream side from the upstream side was adjusted such that the bead length might be 15±5 mm. Further, there were labyrinth packings (not shown) in the upstream and downstream sides of the beads. Further, an opening was provided in both edges. Further, an edge suctioning device (not shown) for reducing the disturbance of the bead was provided.

The material of the casting die was the precipitation hardening stainless steel, whose coefficient of thermal expansion was at most 2×10⁻⁵ (° C.⁻¹). In the compulsory corrosion experiment in an electrolyte solution, the corrosion resistance was almost the same as that of SUS316. Further, the material to be used for the casting die had enough corrosion resistance, such that the pitting (or pitting corrosion) might not occur on the gas-liquid interface even if this material were dipped in a mixture liquid of dichloromethane, methanol and water for three months. The finish accuracy of the contact surface of each casting die 72 and feed block 71 was at most 1 μm in surface roughness, the straightness was at most 1 μm in any directions, and the slit clearance was adjusted to 1.5 mm in straightness. According to an edge of the contact portion of a lip end of the casting die 72, R is at most 50 μm in all of a width. Further, the shearing rate in the casting die is controlled in the range of one to 5000 per second. Further, the WC coating was made on the lip end from the casting die 72 by a melt extrusion method, so as to provide the hardened layer.

In order to prevent the dry and solidification on part of the slit end of the casting die 72, the mixture solvent dissolvable of the solidified dope was supplied to each edge portion of the gas-liquid interface of the slit at 0.5 ml/min. Thus the mixture solvent is supplied to each bead edge. The pulse rate of a pump for supplying the mixture solvent was at most 5%. Further, the decompression chamber 81 was provided for decreasing the pressure in the rear side by 150 Pa. In order to control the temperature of the decompression chamber 81, a jacket (not shown) was provided, and a heat transfer medium whose temperature was controlled at 55° C. was supplied into the jacket. The edge suction rate could be controlled in the range of 1 L/min to 100 L/min, and was adequately controlled in this experiment so as to be in the range of 30 L/min to 40 L/min.

The belt 73 was an endless stainless belt which was 2.1 m in width and 70 m in length. The thickness of the belt 73 was 1.5 mm, and the surface of the belt 73 was polished, such that the surface roughness might be at most 0.05 μm. The material was SUS316, which had enough corrosion resistance and strength. The thickness nonuniformity of the entire belt 73 was at most 0.5% of the predetermined value. The belt 73 was moved by rotating the back-up rollers 74a, 74b. At this moment, the tension of the belt 73 was controlled to 1.5×10⁴ kg/m. Further, the relative speed to each roller to the belt 73 changed. However, in this experiment, the control was made such that the difference of the relative speed between the back-up rollers 74a, 74b was at most 0.01 m/min. Further the control was made such that the variation of the speed of the belt 73 was at most 0.5% to the predetermined value. The position of the belt in the widthwise direction was controlled with detection of the position of the side end, such that meandering in one circle of the moving belt 73 was reduced in 1.5 mm. Further, below the casting die 72, the variation of the position in the vertical direction between the lip end of the casting die and the belt 73 was in 200 μm. The three dopes (for forming the base layer and the first and second outer layers) were cast onto the belt 73 from the casting die 72.

In this experiment, the back-up rollers 74a, 74b were supplied therein with a heat transfer medium, such that the temperature of the belt 73 might be controlled. The back-up roller 74a disposed in a side of the casting die 72 was supplied with the heat transfer medium at 5° C., and the back-up roller 74b was supplied with the heat transfer medium at 40° C. The surface temperature of the middle portion of the belt 73 at a position just before the casting was 15° C., and the temperature difference between both sides of the belt was at most 6° C. Note that a number of pinhole (diameter, at most 30 μm) was zero, a number of pinhole (diameter, 10 μm to 30 μm) was at most one in square meter, and a number of pinhole (diameter, less than 10 μm) was at most two in square meter.

The temperature of the casting chamber 70 controlled to 35° C. by the temperature controlling device 77. The first air duct 82 was positioned just after the casting dope was cast from the casting die 72, and the outlets 82a of the first air duct 82 opened in parallel direction to the belt 73. Further, in downstream from the first air duct 82, the second air duct 83 was positioned and the outlet 83a of the second air duct 83 was directed in the running direction of the belt 73, such that the second drying air may be fed out toward the surface side from the belt 73. As first air duct 82, as shown in FIG. 4, the partitioning members partitioned each outlet 82a into three partitions in widthwise direction of the casting film 80, and the meshed plates 124 were attached to two edge areas confronting to both side edge portions of the casting film 80. According to the first drying air fed out from the outlets 82a, the temperature was 140° C., and the static pressure was 147 Pa. Further, when the content of remaining solvent in the casting film became less than 250 wt. %, the second drying air at 140° C. was fed out from the second air duct 83 at 10 m/sec of wind speed.

The overall heat transfer coefficient from the drying airs to the casting film 80 was 24 kcal/(m²·hr·° C.). The oxygen concentration in the drying atmosphere on the belt 73 was kept at 5 vol. %. In order to keep the oxygen concentration at 5 vol. %, the air was substituted by the nitrogen gas. Further, in order to condense and recover the solvent in the casting chamber 70, the condenser 78 was provided, and the temperature of the exit was set to −10° C.

Air shielding members were disposed such that the first drying air might not be applied to the casting dope and the casting film 80 in 5 seconds after the casting. The static pressure fluctuation around the casting die 72 was in ±1 Pa. When the solvent ratio in the casting film became 150 mass % of dry weight standard, the casting film 80 was peeled as the film 101 from the belt 73 with support of the peeling roller 86. At the peeling, the peeling tension was 10 kgf/m. Further, in order to reduce the peeling defect, the peeling speed was adequately controlled such that the percentage thereof to the speed of the belt 73 might be in the range of 100.1% to 105%. The surface temperature of the film 101 was 15° C.

According to the drying speed, 60 mass % of the solvent in dry weight standard was evaporated per minute in average. The solvent vapor generated in the drying was condensed at −10° C. by the condenser 78, and recovered by the recovering device 79. The recovered solvent was reused after the conditioning thereof. At this moment, the water content in the solvent was at most 0.5%. The air from which the solvent was removed was heated again and reused as the drying air. The film 101 was transported toward the tenter device 100 by the rollers in the transfer area 90. At this moment, the air blower 91 fed the drying air at 40° C. to the film 101.

In the tenter device 100, both side edge portions of the film 101 was held by clips, and then transported in a drying zone for performing the drying. The clip was supplied with a heat transfer medium at 20° C. The drive of the tenter device 100 was made with use of chain, and the speed variation of sprockets of the chain was at most 0.5%. Further, the inside of the tenter device 100 was partitioned into three zones, in which the temperatures of the drying airs were 90° C., 100° C. and 110° C. sequentially from the upstream side. The drying air had composition so as to be saturated at −10° C. According to the drying speed in the tenter device 100, the 120 mass % of the solvent of dry weight standard was evaporated per minute in average. The conditions of the drying zones were adjusted such that the remaining content of the solvent in the film might be 7 mass % at an exit of the tenter device 100.

Further, in the tenter device 100, the stretching in the widthwise direction was made as the transportation was made. If the percentage of the film width of the film 101 before the tenter device 100 was determined to 100%, the stretching ratio of the film width after the tenter device 100 was 103%. Further, the film was drawn in the lengthwise direction between the peeling roller 86 and the tenter device 100. The drawing ratio in percentage was 102%. According to the stretching ration in the tenter device 100, the difference of the actual stretching ratio was at most 10% between parts which were at least 10 mm apart from the holding positions of the clips, and at most 5% between parts which were 20 mm apart from the holding portions. In the side edge portions in the tenter device 100, the ratio of the length in which the fixation was made was 90%. The solvent vapor generated in the tenter device 100 was condensed at −10° C. to a liquid state and recovered. For the condensation, a condenser (not shown) was provided, and a temperature at an exit thereof was −8° C. The water content in the recovered solvent was regulated to at most 0.5 mass %, and then the recovered solvent was reused. The film 101 was fed out as the film 101 from the tenter device 100.

In 30 seconds from exit of the tenter device 100, both side edge portions were slit off in the edge slitting device 102. In this experiment, each side portion of 50 mm in the widthwise direction of the film 101 was determined as the side edge portion, which were slit off by an NT type slitter of the edge slitting device 102. The slit side edge portions were sent to the crusher 103 by applying air blow from a blower (not shown), and crushed to tips about 80 mm². The tips were stored into edge silos for reusing as raw material with the TAC flakes for the dope production. The oxygen concentration in the drying atmosphere in the tenter device 100 was kept to 5 vol. %. Note that the air was substituted by nitrogen gas in order to keep the oxygen concentration at 5 vol. %. Before the drying at the high temperature in the drying chamber 105, the pre-heating of the film 101 was made in a pre-heating chamber (not shown) in which the air blow at 100° C. was supplied.

The film 101 was dried at high temperature in the drying chamber 105, which was partitioned into four partitions. Air blows whose temperatures were 120° C., 130° C., 130° C. and 130° C. from the upstream side were fed from air blowers (not shown) to the partitions. The transporting tension of each roller 104 to the film 101 was 100 N/width. The drying was made for ten minutes such that the content of the remaining solvent might be 0.3 mass %. The lapping angle of the roller 104 was 900 and 180°. The rollers 104 were made of aluminum or carbon steel. On the surface, the hard chrome coating was made. The surfaces of the rollers 104 were flat or processed by blast of matting process. The swing of the roller in the rotation was in 50 μm. Further, the bending of each roller 104 at the tension of 100 N/width was reduced to at most 0.5 mm.

The solvent vapor contained in the drying air is removed with use of the adsorbing device 106 in which an adsorbing agent was used. The adsorbing agent was active carbon, and the desorption was performed with use of dried nitrogen. The recovered solvent was reuse as the solvent for the dope preparation after the water content might be at most 0.3 mass %. The drying air contains not only the solvent vapor but also gasses of the plasticizer, UV-absorbing agent, and materials of high boiling points. Therefore, a cooler for removing by cooling and a preadsorber were used to remove them. Thus the drying air was reused. The ad- and desorption condition was set such that a content of VOC (volatile organic compound) in exhaust gas might be at most 10 ppm. Furthermore, in the entire solvent vapor, the solvent content to be recovered by condensation method was 90 mass %, and almost of the remaining solvent vapor was recovered by the adsorption recovering.

The dried film 101 was transported into a first humidity control chamber (not shown). Between the drying chamber 105 and the first humidity control chamber, there was the transfer area 90 into which a drying air at 110° C. was fed. In the first humidity control chamber, an air whose temperature and dewing point were respectively 50° C. and 20° C. was fed. Further, the film 101 was transported into a second humidity control chamber (not shown) for preventing the curling of the film 101. In the second humidity control chamber, an air whose temperature and humidity were respectively 90° C. and 70% was directly applied.

After the humidity control, the film 101 was cooled in the cooling chamber 107 such that the temperature of the film might be at most 30° C. Then the edge slitting of both film edge portions were made. Further, the compulsory neutralization device (or a neutralization bar) 108 eliminated the charged electrostatic potential of the film 101 in the range of −3 kV to +3 kV. After the neutralization, the embossing of both side portions of the film 101 was made by the knurling rollers 109 to provide the knurling. The knurling width was 10 mm, and the knurling pressure was determined such that the maximal emboss height might be 12 μm in average larger than the averaged thickness.

The film 101 was transported to the winding chamber 110, whose inside temperature and humidity were respectively kept to 28° C. and 70%. Further, a compulsory neutralization device (not shown) was provided, such that the charged electrostatic potential of the film might be in the range of −1.5 kV to +1.5 kV. The obtained film 101 was 1475 mm in width. The diameter of the winding shaft 111 was 169 mm. The tension pattern was set such that the winding tension was 360 N/width at first, and 250 N/width at last. The film 101 was entirely 3940 m in length. The winding cycle was 400 m, and the oscillation width was in +5 mm. Further, the pressure of the press roller 112 to the winding shaft 111 was set to 50 N/width. The temperature of the film at the winding was 25° C., the water content was 1.4 mass %, and the content of the remaining solvent was 0.3 mass %. Through all processes, the averaged drying speed was 20 mass %/min.

### EXAMPLE 2

The film 101 was produced from the same dope by the same method as Example 1. However, the first drying air was fed out from the first air duct 82, such that the static pressure of the first drying air might be 9.6 Pa.

### EXAMPLE 3

The film 101 was produced from the same dope by the same method as Example 1. However, the first drying air was fed out from the first air duct 82, such that the static pressure of the first drying air might be 294 Pa.

### EXAMPLE 4

The film 101 was produced from the same dope by the same method as Example 1. However, the first drying air was fed out from the first air duct 82, such that the temperature of the first drying air might be 40° C.

### EXAMPLE 5

The film 101 was produced from the same dope by the same method as Example 1. However, the first drying air was fed out from the second air duct 83, such that the temperature of the first drying air might be 20° C.

### EXAMPLE 6

The film 101 was produced from the same dope by the same method as Example 1. However, the first drying air was fed out from the second air duct 83, such that the wind speed of the first drying air might be 30 m/sec.

### EXAMPLE 7

The film 101 was produced from the same dope by the same method as Example 1. However, the outer layer dope was prepared such that the viscosity might be 60 Pa·s.

### EXAMPLE 8

The film 101 was produced from the same dope by the same method as Example 1. However, the second air duct 83 was not used for the drying.

[Estimation of Film]

The surface of the production film was observed with eyes how much there are unevenness and whether the foaming occurred. According to the unevenness (Uneven. in Table 1) and the foaming (Foam. in Table 1), if they were observed very little, the estimation was A. If they were observed little, the estimation was B. If they were observed relatively much but the film can be used in the optical field, the estimation was C. If they were observed so much, the estimation was N.

The results of estimations of the produced film in the above estimations will be described in Table 1.

TABLE 1

| | 1^{st} air duct | | 2^{nd} air duct | | Vₒᵤₜ | Estimation | |
|---|---|---|---|---|---|---|---|
| | T (° C.) | SP (Pa) | T (° C.) | WS (m/s) | (Pa · s) | Uneven. | Foam. |
| Ex. | 140 | 147 | 140 | 10 | 25 | A | A |
| 1 | | | | | | | |
| Ex. | 140 | 19.6 | 140 | 10 | 25 | B | BS |
| 2 | | | | | | | |
| Ex. | 140 | 294 | 140 | 10 | 25 | N | C |
| 3 | | | | | | | |
| Ex. | 40 | 147 | 140 | 10 | 25 | N | B |
| 4 | | | | | | | |
| Ex. | 140 | 147 | 20 | 10 | 25 | C | B |
| 5 | | | | | | | |
| Ex. | 140 | 147 | 140 | 30 | 25 | C | B |
| 6 | | | | | | | |
| Ex. | 140 | 147 | 140 | 10 | 60 | N | B |
| 7 | | | | | | | |
| Ex. | 140 | 147 | — | — | 25 | N | C |
| 8 | | | | | | | |

Vₒᵤₜ: Viscosity of Dope for Outer Layer
T: Temperature
SP: Static pressure
WS: Wind Speed

As know from Table 1, if the static pressure of the first drying air fed out from the first air duct 82 was changed (Examples 1-3), the amount of the occurrence of the unevenness and the foaming became different. In Example 1, the unevenness and the foaming occurred only very little. In Example 2 in which the static pressure was smaller than Example 1, the estimation of the film was little worse. In Example 3 in which the static pressure was larger than Example 1, the estimation was very worse. Therefore, the largeness of the static pressure of the first air duct 82 has an influence on the grades of occurrence of the unevenness and the foaming. Further, if the static pressure of the first air duct 82 was almost constant in the range of 49 Pa to 196 Pa, the excellent film in planarity was produced.

In Example 4, the temperature of the first drying air fed out from the first air duct 82 was 40° C. As a result, in the produced film 101 the foaming was relatively little (Estimation, B), but the unevenness was so much (Estimation, N). In Example 4, the conditions for producing the film were the same as Example 1 except of the temperature of the first drying air from the first air duct 82. Therefore, the largeness of the static pressure at the feed out from the first air duct 82 has an influence on the grades of occurrence of the unevenness and the foaming. Further, if the temperature of the first drying air fed out from the first air duct 82 was almost constant in the range of 50° C. to 160° C., the excellent film in planarity was produced.

In Example 5, the temperature of the second drying air fed out from the second air duct 83 was 20° C. As a result, in the produced film 101 the foaming was relatively little (Estimation, B), but the unevenness was relatively much (Estimation, C). In Example 5, the conditions for producing the film were the same as Example 1 except of the temperature of the second drying air from the second air duct 83. Therefore, the largeness of the temperature at the feed out from the second air duct 83 has an influence on the grades of occurrence of the unevenness and the foaming. Further, if the temperature of the second drying air fed out from the second air duct 83 was almost constant in the range of 50° C. to 160° C. the same as from the first air duct 82, the excellent film in planarity was produced.

In Example 6, the wind speed of the second drying air fed out from the second air duct 83 was 30 m/sec. As a result, in the produced film 101 the foaming was relatively little (Estimation, B), but the unevenness was relatively much (Estimation, C). In Example 6, the conditions for producing the film were the same as Example 1 except of the wind speed of the second drying air from the second air duct 83. Therefore, the largeness of the wind speed at the feed out from the second air duct 83 has an influence on the grades of occurrence of the unevenness and the foaming. Further, if the temperature of the first drying air fed out from the first air duct 82 was almost constant in the range of 5 m/sec to 20 m/sec, the excellent film in planarity was produced.

In Example 7, the viscosity of the outer layer dope was 60 Pa·s. As a result, in the produced film 101 the foaming was relatively little (Estimation, B), but the unevenness was much (Estimation, N). In Example 7, the conditions for producing the film were the same as Example 1 except of the viscosity of the outer layer dope. Therefore, the largeness of the viscosity of the outer layer dope has an influence on the grades of occurrence of the unevenness and the foaming. Further, if the viscosity of the outer layer dope was almost constant at most 40 Pa·s, the excellent film in planarity was produced.

In Example 8, the second air duct 83 was not used, but only the first air duct was used in the upper side from the belt 73. As a result, in the produced film 101 the foaming was so much (Estimation, N), and the unevenness was relatively much (Estimation, C). In Example 8, the conditions for producing the film were the same as Example 1 except that no second drying air was fed out from the second air duct 83. Therefore, if both of the first and second air duct were used, the excellent film in planarity was produced.

1. A method of producing a film from a casing dope containing solvent and polymer, comprising steps of:
casting said casting dope from a casting die on a running support so as to form a casting film;
feeding out a first drying air from at least one first outlet confronting to said support so as to extend in a widthwise direction of said support and be situated closely in downstream from said casting die, a temperature of said first drying air being almost constant in the range of 50° C. to 160° C., a static pressure to said first drying air at the feeding is in the range of 50 Pa to 200 Pa;
feeding out a second drying air from a second outlet disposed in downstream from said first outlet and in a casting side from said support when a content of remaining solvent in said casting film decreases to a predetermined value, said outlet opening in a running direction such that said drying air may flow in parallel to said support;
peeling said casting film containing said solvent as said film; and
drying said film containing said solvent.

2. A method described in claim 1, wherein a plurality of partitioning members are disposed in said first outlet so as to partition said first outlet into at least three partitions in a widthwise direction of said support.

3. A method described in claim 2, wherein air volume regulation members are attached onto the closest partitions to both side edge portions of said casting film, so as to regulate a volume of said first drying air in a widthwise direction of said support.

4. A method described in claim 1, wherein the feeding of said first drying air is performed until the content of remaining solvent in said casting film decreases to 250 wt. %.

5. A method described in claim 1, wherein a temperature of said second drying air is almost constant in the range of 50° C. to 160° C. and a wind speed of said second drying air is almost constant in the range of 5 m/s to 20 m/s.

6. A method described in claim 1, wherein said casting film has a multi-layer structure constructed of a base layer contacting to said support and an exposure layer exposed to an atmosphere, said casting dope includes a base layer dope for forming said base layer and an exposure layer dope for forming said exposure layer, and the casting of said casting dope is a co-casting of said base layer dope and said exposure layer dope.

7. A method described in claim 6, wherein a viscosity of said exposure layer dope is at most 40 Pa·s.

8. A method described in claim 1, wherein said first outlet has a slit-like form and a plurality of said first outlets is arranged in the running direction of said support.

9. A method described in claim 8, wherein an angle of a feeding direction of said first drying air toward said casting film on said support to said support is in the range of 30° to 90°.
